(19) United States
(12) Patent Application Publication
(10) Pub. No.: US 2026/0317563 A1
(43) Pub. Date: Oct. 15, 2026

(54) SCRATCH RESISTANT ONE-PACK COATING MATERIAL

(71) Applicant: BASF COATINGS GMBH, Muenster (DE)

(72) Inventors: Jan WINSBERG, Muenster (DE); Christian WEIHER, Muenster (DE); Guenter KLEIN, Muenster (DE); Karin HOMANN, Muenster (DE); Berthold AUSTRUP, Muenster (DE); Ulrike WENKING, Muenster (DE)

(21) Appl. No.: 19/122,589

(22) PCT Filed: Nov. 13, 2023
(86) PCT No.: PCT/EP23/81661

§ 371 Date: Apr. 18, 2025

(30) Foreign Application Priority Data
Nov. 8, 2022 (EP) 22206243.2

(51) Int. Cl. C09D 7/80; C08G 18/28; C08G 18/42; C08G 18/62; C08G 18/63; C08G 18/75; C08G 18/79; C08G 18/80

(52) U.S. Cl. CPC C09D 7/80; C08G 18/282; C08G 18/289; C08G 18/42; C08G 18/6225; C08G 18/63; C08G 18/755; C08G 18/758; C08G 18/792; C08G 18/807; C08G 18/8096

(57) ABSTRACT

Disclosed herein is a one-pack coating material, including a) at least one hydroxy-functional polymer (A) selected from the group consisting of (meth)acrylic polymers, polyesters and polyurethanes; b) at least one crosslinking agent (B) of general formula (I) being [R—(C═O)NH]_{z}R^{org}, and c) an aprotic organic solvent, where 2.0 to 30 wt.-% of the at least one crosslinking agent (B) are contained in the one-pack coating material, based on the total weight of the one-pack coating material. Further disclosed herein are a method for forming a coating on a substrate making use of the one-pack coating material, a coated substrate obtained by the method, a multilayer coating including a coating layer formed from the one-pack coating material, and a coated substrate with the multilayer coating.

### FIELD OF THE INVENTION

The present invention relates to one-pack coating materials, particularly one-pack clear coat materials comprising a hydroxy-functional polymeric binder and an alkoxysilane based crosslinking agent. The invention further relates to a method of forming a coating on a substrate using such coating materials and thus coated substrates. Moreover, the invention relates to multilayer coatings comprising a coating layer formed from the coating materials of the invention and thus coated substrates.

### BACKGROUND OF THE INVENTION

Clearcoat coatings are typically the outermost coating of coated substrates, particularly multilayer coated substrates. Therefore, they are prone to all environmental influences such as weathering and mechanical impacts. One kind of a mechanical impact is the contact with abrasive material, such as brushes used for cleaning the coated substrates or sand from the environment. This kind of mechanical impact strongly reduces the gloss of the coatings.

Thus, there is an ongoing need for improved scratch-resistant clearcoat coatings.

For coatings formed from two-pack coating materials (also called two-component coating materials) two major approaches to improve scratch resistance exist.

The first approach is the incorporation of surface-modified silica nano-particles that migrate to the clearcoat-air interface in the flash-off phase, i.e., the phase after application of the clearcoat to the substrate in which some of the solvents contained in the coating layer evaporate, but the layer is not fully dried, nor substantially cured. The migration of the silica nanoparticles to the clearcoat-air surface leads to an enrichment of such particles at the surface and surface near area of the coating layer and after curing such layer exhibits an improved scratch resistance. Detrimental in this approach is that strong or long abrasive impact on the surface may lead to a partial loss of the silica nanoparticles in the outermost part of the clearcoat layer, which consequently is accompanied by a loss of the scratch resistance effect.

A second approach makes use of silane-modified polymers or oligomers, to form a hybrid clearcoat matrix featuring a thermoset clearcoat matrix marbled with silica nanoclusters. This approach is preferred, since the scratch-resistance is more durable and more weather resistant compared to standard two-pack clearcoats.

The problem with two-pack compositions as such is that they require the separate storage of at least two parts of the final coating material, namely the so-called base paint composition comprising crosslinkable polymers and the hardener composition comprising a crosslinker. Neither the base paint composition, nor the hardener composition themselves are apt to form durable coatings, however, directly upon mixing a reaction between base paint and hardener starts, resulting in a limitation of pot life. With other words the final two-pack coating materials are not storage stable.

Therefore, the present invention aims to provide one-pack coating materials, which do not require the storage of at least two separate parts of the composition as required for two-pack coating materials and which are storage stable as such.

However, transferring the favorable second approach of improving scratch resistance as discussed above from two-pack coating materials to one-pack coating materials was not yet technically feasible because the resulting one-pack compositions where either not long-term stable or not reactive enough to sufficiently crosslink in the baking phase to result in an improvement of the properties of the corresponding clearcoats.

### SUMMARY OF THE INVENTION

In the light of the above, it was the aim of the present invention to provide a one-pack coating material, preferably a clearcoat composition possessing an excellent storage stability and humidity resistance, and which is based on silane-modified substances and form coatings, which, in cured state, show an excellent scratch resistance. The coatings should further have a good adherence on various substrates including coated substrates, thus being apt to be part of multilayer coating systems, preferably as the outermost layer.

The aims and objects described above are achieved by the subject matter claimed in the claims and also by the preferred embodiments of the respective subject matter which is described hereinafter.

A first subject matter of the present invention is therefore a one-pack liquid coating material, comprising
a) at least one hydroxy-functional polymer (A) selected from the group consisting of (meth)acrylic polymers, polyesters and polyurethanes;
b) at least one crosslinking agent (B) of general formula (I)

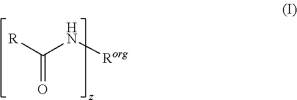

wherein
R^{org} is an organic residue and z=2.0 to 9.0, and
R is selected from the group consisting of alkoxysilane groups containing groups of formulae (II) and (III) and isocyanate blocking groups, formula (II) being

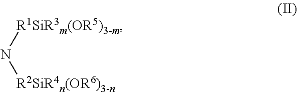

wherein
R¹ and R² are independently from each other selected from linear, branched, and cyclic alkylene groups having 1 to 10 carbon atoms,
R³ and R⁴ are independently from each other selected from linear, branched, and cyclic alkyl groups having 1 to 10 carbon atoms,
R⁵ and R⁶ are independently selected from alkyl residues containing 2, 3 or 4 carbon atoms, and
n and m are independently of each other 0, 1 or 2;
formula (III) being

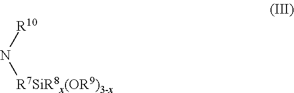

wherein
R⁷ is selected from linear, branched, and cyclic alkylene groups having 1 to 10 carbon atoms,
R⁸ is selected from linear, branched, and cyclic alkyl groups having 1 to 10 carbon atoms,
R⁹ is selected from alkyl residues containing 2, 3 or 4 carbon atoms,
R¹⁰ is selected from H and linear, branched, and cyclic alkyl groups having 1 to 10 carbon atoms and
x being 0, 1 or 2; and
isocyanate blocking groups R^{b} being formally derived from isocyanate blocking agents of formula H—R^{b} by formal removal of H at the atom of residue R^{b}, which is bound to the carbon of the C═O group in formula (I);
with the proviso that on average at least 15 mole-% of the entirety of residues R in formula (I) are residues of formula (II), and
c) an aprotic organic solvent, wherein
2.0 to 30 wt.-% of the at least one crosslinking agent (B) are contained in the one-pack coating material, based on the total weight of the one-pack coating material.

The above-specified coating materials are hereinafter also referred to as coating materials of the invention and accordingly are a subject of the present invention.

Thus, due to the proviso, groups of formula (II) are mandatory, while the presence of groups of formula (III) and/or of isocyanate blocking groups is just optional.

The term “coating material” according to DIN EN ISO 4618:2015-01 is used for a product, in liquid, paste or powder form, that, when applied to a substrate, forms a layer possessing protective, decorative and/or other specific properties. Herein, the coating materials contain one or more aprotic organic solvents and are thus liquid coating materials.

The term “one-pack coating material”, in contrast to “two-pack coating materials”, are coating materials containing a crosslinkable component and a crosslinking agent component, where these components do not pre-maturely react with each other (see Rompp Lexikon Lacke und Druckfarben, Georg Thieme Verlag, 1998, page 179, keyword “Einkomponenten-Lacke” (one-pack coatings)).

The term “(meth)acrylic” includes “acrylic” and “methacrylic”. Thus, the term “(meth)acrylic polymer” refers to polymers containing acrylic monomers, methacrylic monomers or both. Such polymers may comprise further ethylenically unsaturated monomers.

A further subject matter of the present invention is a method for forming a coating on a substrate(S) comprising the following steps:
(1) applying a coating material of the invention onto the substrate(S);
(2) forming a coating film from the coating material applied in step (1); and
(3) curing the coating film formed in step (2).

The above-specified method for forming a coating on a substrate is hereinafter also referred to as coating method of the invention.

Another subject matter of the present invention is a coated substrate obtainable by the coating method of the invention.

The afore-mentioned coated substrate is hereinafter also referred to as coated substrate of the invention.

Yet another subject matter of the present invention is a multilayer coating comprising at least two coating layers, preferably at least one basecoat layer and at least one clearcoat layer, wherein at least one of the coating layers, preferably the clearcoat layer, is formed from the inventive coating material.

The afore-mentioned multilayer coating is hereinafter also referred to as multilayer coating of the invention.

A further subject matter of the present invention is a substrate coated with an inventive multilayer coating.

The afore-mentioned substrate coated with a multilayer coating of the invention is hereinafter also referred to as multilayer coated substrate of the invention.

Preferred embodiments of coating materials of the invention, coating methods of the invention, coated substrates of the invention, multilayer coatings of the invention and the multilayer coated substrates are apparent from the description hereinafter and also from the dependent claims.

### DETAILED DESCRIPTION

The measurement methods to be employed in the context of the present invention for determining certain characteristic variables can be found in the Examples section. Unless explicitly indicated otherwise, these measurement methods are to be employed for determining the respective characteristic variable. Where reference is made in the context of the present invention to an official standard without any indication of the official period of validity, the reference is implicitly to the latest version of the standard that is valid on the filing date, or, in the absence of any valid version at that point in time, to the last valid version.

In accordance with the “Compendium of Polymer Terminology and Nomenclature” (IUPAC Recommendations 2008; RSCPublishing; ISBN: 978-0-85404-491-7) it is distinguished between molecules and substances; the substances being composed of molecules. As used herein a monomer is a substance composed of monomer molecules, an oligomer is a substance composed of oligomer molecules and a polymer is a substance composed of polymer molecules (macro molecules). Monomer molecules can undergo polymerization, thereby contributing constitutional units to the essential structure of a macromolecule. Oligomer molecules are molecules of intermediate relative molecular mass, the structure of which essentially comprises a small plurality of units derived (actually or conceptually) from molecules of lower relative molecular mass. Polymer molecules, i.e., macromolecules, are molecules having a high relative molecular mass, which essentially comprises the multiple repetition of units derived (actually or conceptionally) from molecules of low relative molecular mass. For the present invention it is not necessary to distinguish between oligomers and polymers. Unlike single molecules, substances, which by definition consist of a plurality of molecules, do not necessarily have an exact molecular weight. If a substance, particularly a monomer consists of a plurality of identical molecules, the molecular weight of such substance is identical to the molecular weight of the single molecules, i.e., the number-average molecular weight Mₙ and weight-average molecular weight M_{w} of the substance is identical (Mₙ=M_{w}). However, if the substance is an oligomer or even a polymer, the single oligomer molecules forming the oligomer or the macromolecules forming the polymer may differ in their molecular weights, e.g., due to different numbers of monomeric units constituting the oligomer molecules or macromolecules. Thus, in case of oligomers and polymers the so-called polydispersity PD=M_{w}/Mₙ might be larger than 1. Herein, particularly the hydroxy-functional polymers (A) and the crosslinking agents (B), but also other oligomeric and polymeric ingredients are considered to be substances and thus to possess number-average molecular weights Mₙ and weight-average molecular weights M_{w} which may differ from each other. Thus, in case of the presence of a number of functional groups in substances, percentage of functional groups in substances or parameters characterizing such substances, as, e.g., hydroxyl numbers, such numbers, percentages and parameters are also number averages over the whole population of single molecules constituting the respective substance.

### Coating Materials

The liquid coating materials of the present invention contain at least one hydroxy-functional polymer (A), at least one crosslinking agent (B) and at least one aprotic organic solvent (C), all as generally defined above and specifically defined hereinafter.

As already explained above, the coating materials of the invention are one-pack coating materials, the ingredients of which do not pre-maturely react with each other. Since the coating materials of the present invention contain moisture sensitive groups, i.e., hydrolysable silane groups, it is inherent that in the one-pack coating material of the invention, no water is employed intentionally, to avoid pre-mature curing. Thus, the ingredients employed should preferably be water-free. However, sometimes minor unavoidable amounts of water may be present. In such cases, the total amount of water based on the total weight of the coating material should preferably not exceed 1 wt.-%, even more preferred it should be in the range from 0 to 1.0 wt.-%, even more preferred from 0 to 0.5 wt.-% based on the total weight of the coating material. Being one-pack coating materials, the coating materials of the present invention should preferably not contain substances having free isocyanate groups (NCO groups). If contained in minor residual amounts, the NCO content of the one-pack coating material of the present invention should not exceed 1 wt.-% of NCO groups, even more preferred the content should be in the range from 0 to 1.0 wt.-%, even more preferred from 0 to 0.5 wt.-% based on the total weight of the coating material

The one-pack coating material of the present invention is preferably a basecoat material and/or a topcoat material (i.e., a finishing coat material, which by definition according to DIN EN ISO 4618:2015-01 forms the final coat of a coating system), the topcoat material preferably being a clearcoat material (i.e., a clear coating material, which by definition according to DIN EN ISO 4618:2015-01 is coating material which when applied to a substrate forms a solid transparent film having protective, decorative or specific technical properties). Most preferred the coating material of the present invention is a clear coat material. Particularly preferred the coating material of the present invention is an automotive coating material, i.e., a coating material used in automotive coating, preferably as a clear coat material.

### Hydroxy-Functional Polymer (A)

The hydroxy-functional polymer (A) as used in the coating materials of the present invention is selected from the group consisting of (meth)acrylic polymers, polyesters, and polyurethanes.

The hydroxy groups in (meth)acrylic polymers are preferably introduced by hydroxy group containing monomers. Therefore, the hydroxy-functional (meth)acrylic polymers preferably contain hydroxy-functional monomers such as hydroxy alkyl esters of acrylic or methacrylic acid. Nonlimiting examples of hydroxyl-functional monomers include hydroxyethyl(meth)acrylate, hydroxypropyl(meth)acrylates, hydroxybutyl(meth)-acrylates, hydroxyhexyl(meth)acrylates, propylene glycol mono(meth)acrylate, 2,3-dihydroxypropyl(meth)acrylate, pentaerythritol mono(meth)acrylate, polypropylene glycol mono(meth)acrylates, polyethylene glycol mono(meth)acrylates, reaction products of these with epsilon-caprolactone, and other hydroxyalkyl (meth)acrylates having branched or linear alkyl groups of up to about 10 carbons, and mixtures of these. Hydroxyl groups on a vinyl polymer such as a (meth)acrylic polymer can also be generated by other means, such as, for example, the ring opening of a glycidyl group, for example from copolymerized glycidyl methacrylate, by an organic acid or an amine.

Examples of suitable comonomers that may be used in the preparation of (meth)acrylic polymers include, without limitation, α,β-ethylenically unsaturated monocarboxylic acids containing 3 to 5 carbon atoms such as acrylic, methacrylic, and crotonic acids and the alkyl and cycloalkyl esters, nitriles, and amides of acrylic acid, methacrylic acid, and crotonic acid; α,β-ethylenically unsaturated dicarboxylic acids containing 4 to 6 carbon atoms and the anhydrides, monoesters, and diesters of those acids; vinyl esters, vinyl ethers, vinyl ketones, and aromatic or heterocyclic aliphatic vinyl compounds. Representative examples of suitable esters of acrylic, methacrylic, and crotonic acids include, without limitation, those esters from reaction with saturated aliphatic alcohols containing 1 to 20 carbon atoms, such as methyl, ethyl, propyl, isopropyl, n-butyl, isobutyl, tert-butyl, hexyl, 2-ethylhexyl, dodecyl, 3,3,5-trimethylhexyl, stearyl, lauryl, cyclohexyl, alkyl-substituted cyclohexyl, alkanol-substituted cyclohexyl, such as 2-tert-butyl and 4-tert-butyl cyclohexyl, 4-cyclohexyl-1-butyl, 2-tert-butyl cyclohexyl, 4-tert-butyl cyclohexyl, 3,3,5,5,-tetramethyl cyclohexyl, tetrahydrofurfuryl, and isobornyl acrylates, methacrylates, and crotonates; unsaturated dialkanoic acids and anhydrides such as fumaric, maleic, itaconic acids and anhydrides and their mono- and diesters with alcohols such as methanol, ethanol, propanol, isopropanol, butanol, isobutanol, and tert-butanol, like maleic anhydride, maleic acid dimethyl ester and maleic acid monohexyl ester; vinyl acetate, vinyl propionate, vinyl ethyl ether, and vinyl ethyl ketone; styrene, a-methyl styrene, vinyl toluene, 2-vinyl pyrrolidone, and p-tert-butylstyrene.

The (meth)acrylic polymer may be prepared using conventional techniques, such as by heating the monomers in the presence of a polymerization initiating agent and optionally a chain transfer agent. The polymerization may be carried out in solution, for example. Typical initiators are organic peroxides such as dialkyl peroxides such as di-t-butyl peroxide, peroxyesters such as t-butyl peroxy 2-ethylhexanoate, and t-butyl peracetate, peroxydicarbonates, diacyl peroxides, hydroperoxides such as t-butyl hydroperoxide, and peroxyketals; azo compounds such as 2,2′-azobis(2-methylbutanenitrile) and 1,1′-azobis(cyclohexanecarbonitrile); and combinations of these. Typical chain transfer agents are mercaptans such as octyl mercaptan, n- or tert-dodecyl mercaptan; halogenated compounds, thiosalicylic acid, mercaptoacetic acid, mercaptoethanol and the other thiol alcohols already mentioned, and dimeric alpha-methyl styrene.

The polymerization reaction is usually carried out at temperatures from about 20° C. to about 200° C. The reaction may conveniently be done at the temperature at which the solvent or solvent mixture refluxes, although with proper control a temperature below the reflux may be maintained. The initiator should be chosen to match the temperature at which the reaction is carried out, so that the half-life of the initiator at that temperature should preferably be no more than about thirty minutes. Further details of addition polymerization generally and of polymerization of mixtures including (meth)acrylate monomers is readily available in the polymer art. The solvent or solvent mixture is generally heated to the reaction temperature and the monomers and initiator(s) are added at a controlled rate over a period of time, usually between 2 and 6 hours. A chain transfer agent or additional solvent may be fed in also at a controlled rate during this time. The temperature of the mixture is then maintained for a period of time to complete the reaction. Optionally, additional initiator may be added to ensure complete conversion.

Suitable polyesters polyols may be prepared by reacting: (a) polycarboxylic acids or their esterifiable derivatives, together if desired with monocarboxylic acids, (b) polyols, together if desired with monofunctional alcohols, and (c) if desired, other modifying components. Nonlimiting examples of polycarboxylic acids and their esterifiable derivatives include phthalic acid, isophthalic acid, terephthalic acid, halophthalic acids such as tetrachloro- or tetrabromophthalic acid, adipic acid, glutaric acid, azelaic acid, sebacic acid, fumaric acid, maleic acid, trimellitic acid, pyromellitic acid, tetrahydrophthalic acid, hexahydrophthalic acid, 1,2-cyclohexanedicarboxlic acid, 1,3-cyclohexane-discarboxlic acid, 1,4-cyclohexane-dicarboxlic acid, 4-methylhexahydrophthalic acid, endomethylenetetrahydropthalic acid, tricyclodecanedicarboxlic acid, endoethylenehexahydropthalic acid, camphoric acid, cyclohexanetetracarboxlic acid, and cyclobutanetetracarboxylic acid. The cycloaliphatic polycarboxylic acids may be employed either in their cis or in their trans form or as a mixture of the two forms. Esterifiable derivatives of these polycarboxylic acids include their single or multiple esters with aliphatic alcohols having 1 to 4 carbon atoms or hydroxy alcohols having up to 4 carbon atoms, preferably the methyl and ethyl ester, as well as the anhydrides of these polycarboxylic acids, where they exist. Nonlimiting examples of suitable monocarboxylic acids that can be used together with the polycarboxylic acids include benzoic acid, tert-butylbenzoic acid, lauric acid, isonoanoic acid and fatty acids of naturally occurring oils. Nonlimiting examples of suitable polyols include any of those already mentioned above, such as ethylene glycol, butylene glycol, neopentyl glycol, propanediols, butanediols, hexanediols, diethylene glycol, cyclohexanediol, cyclohexanedimethanol, trimethylpentanediol, ethylbutylpropanediol ditrimethylolpropane, trimethylolethane, trimethylolpropane, glycerol, pentaerythritol, dipentaerythritol, tris-hydroxyethyl isocyanate, polyethylene glycol, polypropylene glycol, and polyols derived from natural oils. Nonlimiting examples of monoalcohols that may be used together with the polyols include butanol, octanol, lauryl alcohol, and ethoxylated and propoxylated phenols. Nonlimiting examples of suitable modifying components include compounds which contain a group which is reactive with respect to the functional groups of the polyester, including polyisocyanates and/or diepoxide compounds, and also if desired, monoisocyanates and/or monoepoxide compounds. The polyester polymerization may be carried out by known standard methods. This reaction is conventionally carried out at temperatures of between 180° C. and 280° C., in the presence, if desired, of an appropriate esterification catalyst. Typical catalysts for the esterification polymerization are protonic acids, Lewis acids, titanium alkoxides, and dialkyltin oxides, for example lithium octanoate, dibutyltin oxide, dibutyltin dilaurate, para-toluenesulfonic acid under reflux with small quantities of a suitable solvent as entraining agent such as an aromatic hydrocarbon, for example xylene, or a (cyclo) aliphatic hydrocarbon, for example cyclohexane.

Polyurethanes having hydroxyl functional groups may also be used in the coating materials along with the branched polyester polyol. Examples of suitable polyurethane polyols include polyester-polyurethanes, polyether-polyurethanes, and polycarbonate-polyurethanes, including, without limitation, polyurethanes polymerized using as polymeric diol reactants polyethers and polyesters including polycaprolactone polyesters or polycarbonate diols. These polymeric diol-based polyurethanes are prepared by reaction of the polymeric diol (polyester diol, polyether diol, polycaprolactone diol, polytetrahydrofuran diol, or polycarbonate diol), one or more polyisocyanates, and, optionally, one or more chain extension compounds. Chain extension compounds, as the term is being used, are compounds having two or more functional groups, preferably two functional groups, reactive with isocyanate groups, such as the diols, amino alcohols, and diamines. Preferably the polymeric diol-based polyurethane is substantially linear (i.e., substantially all of the reactants are difunctional).

Diisocyanates used in making the polyurethane polyols may be aromatic, aliphatic, or cycloaliphatic. Useful diisocyanate compounds include, without limitation, isophorone diisocyanate (IPDI), methylene bis-4-cyclohexyl isocyanate (H12MDI), cyclohexyl diisocyanate (CHDI), m-tetramethyl xylene diisocyanate (m-TMXDI), p-tetramethyl xylene diisocyanate (p-TMXDI), 4,4′-methylene diphenyl diisocyanate (MDI, also known as 4,4′-diphenylmethane diisocyanate), 2,4- or 2,6-toluene diisocyanate (TDI), ethylene diisocyanate, 1,2-diisocyanatopropane, 1,3-diisocyanatopropane, 1,6-diisocyanatohexane (hexamethylene diisocyanate or HDI), 1,4-butylene diisocyanate, lysine diisocyanate, meta-xylylenediioscyanate and para-xylylenediisocyanate, 4-chloro-1,3-phenylene diisocyanate, 1,5-tetrahydro-naphthalene diisocyanate, 4,4′-dibenzyl diisocyanate, and xylylene diisocyanate (XDI), and combinations of these. Nonlimiting examples of higher-functionality polyisocyanates that may be used in limited amounts to produce branched thermoplastic polyurethanes (optionally along with monofunctional alcohols or monofunctional isocyanates) include 1,2,4-benzene triisocyanate, 1,3,6-hexamethylene triisocyanate, 1,6,11-undecane triisocyanate, bicycloheptane triisocyanate, triphenylmethane-4,4′,4″-triisocyanate, isocyanurates of diisocyanates, biurets of diisocyanates, allophanates of diisocyanates, and the like.

Besides the afore-mentioned classes of hydroxy-functional polymers, other hydroxy-functional polymers might optionally be present, such as polyethers, epoxy resins or polycarbonates.

Preferably the hydroxy functional polymers used in the present invention have a hydroxyl number in the range of 100 to 200 mg KOH/g, even more preferred in the range from 150 to 190 mg KOH/g and most preferred in the range of 160 to 180 mg KOH/g as determined by titration. The hydroxyl number (OH number) indicates the number of mg of potassium hydroxide that are equivalent to the amount of acetic acid bound in the acetylation of 1 g of substance. For the determination, the sample is boiled with acetic anhydride in dimethylformamide (DMF), and the resultant acid is titrated with potassium hydroxide solution (DIN 53240-2:2007-11).

The glass transition temperature of the hydroxy functional polymers as used in the present invention is preferably in the range of −60° C. to 25° C., more preferred −50° C. to 0° C. The glass transition temperatures of the hydroxy functional polymers are determined by DSC (differential scanning calorimetry) in accordance with DIN EN ISO 11357-2:2014-07 at a heating rate of 10° C./min.

### Crosslinking Agent (B)

The coating materials of the present invention comprise at least one crosslinking agent (B) of general formula (I)

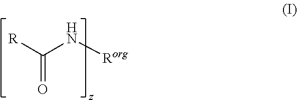

wherein
R^{org} is an organic residue and z=2.0 to 9.0, preferably 2.0 to 6.0, and
R is selected from group consisting of alkoxysilane groups containing groups of formulae (II) and (III) and isocyanate blocking groups,
formula (II) being

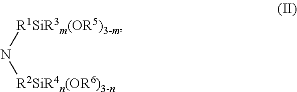

wherein
R¹ and R² are independently from each other selected from linear, branched and cyclic alkylene groups having 1 to 10 carbon atoms,
R³ and R⁴ are independently from each other selected from linear, branched and cyclic alkyl groups having 1 to 10 carbon atoms,
R⁵ and R⁶ are independently selected from alkyl residues containing 2, 3 or 4 carbon atoms, and
n and m are independently of each other 0, 1 or 2;
formula (III) being

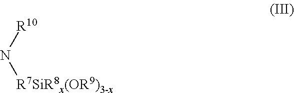

wherein
R⁷ is selected from linear, branched and cyclic alkylene groups having 1 to 10 carbon atoms,
R⁸ is selected from linear, branched and cyclic alkyl groups having 1 to 10 carbon atoms,
R⁹ is selected from alkyl residues containing 2, 3 or 4 carbon atoms,
R¹⁰ is selected from H and linear, branched and cyclic alkyl groups having 1 to 10 carbon atoms; and
x being 0, 1 or 2; and
isocyanate blocking groups R^{b} being formally derived from isocyanate blocking agents of formula H—R^{b} by formal removal of H at the atom of residue R^{b}, which is bound to the carbon of the C═O group in formula (I);
with the proviso that on average at least 15 mole-% of the entirety of residues R in formula (I) are residues of formula (II).

Such crosslinking agents are particularly suitable to crosslink the hydroxy groups of the hydroxy functional polymers (A) as defined above. However, crosslinking agents (B) are also apt to self-crosslinking of the silane groups, which, in many cases is even found to be the predominant reaction.

The crosslinking agents (B) should preferably not contain free isocyanate groups (NCO groups), i.e., the crosslinking agents (B) of the invention should preferably be isocyanate-free. If some NCO containing starting compounds used in the preparation of the crosslinking agents (B) are still contained in the crosslinking agents (B), the content of NCO groups should preferably not exceed 1.0 wt.-%, more preferred the content should be in the range from 0 to 0.7 wt.-%, even more preferred from 0 to 0.5 wt.-%, and most preferred from 0 to 0.3 wt.-% based on the total weight of the crosslinking agent (B).

The crosslinking agents (B) of general formula (I) contain z=2 to 9 R(C═O)NH groups. The value of z is preferably selected by using a diisocyanate or polyisocyanates having isocyanate groups (NCO groups) in the manufacture of the crosslinking agent (B) of general formula (I). Such diisocyanates or polyisocyanates R^{org}(NCO)_{z} are commercially available. However, the average number of NCO groups in such starting substances can be determined from their number-average molecular weights and their NCO content, both of which can be determined as described herein below.

### Organic Residue R^{org}

The organic residue R^{org} are preferably monomeric, oligomeric or polymeric, more preferably monomeric or oligomeric. The organic residues R^{org} can be aliphatic or aromatic. Herein, the term aliphatic residue or compound or group includes acyclic or cyclic (i.e., cycloaliphatic), saturated or unsaturated residues or compounds or groups, excluding aromatic residues or compounds or groups.

If the organic residue R^{org} is a monomeric organic residue R^{m} the value of z is preferably 2.0 to 4.0 or 2.0 to 3.0, more preferably R^{m} is the residue of a diisocyanate OCN—R^{m}—NCO (i.e., z=2) from which the two isocyanate groups are formally removed. E.g., in case of hexamethylene diisocyanate (HDI), such residue R^{m} would be the hexamethylene residue, i.e., the residue between the two isocyanate groups. Such monomeric organic residues R^{m} can be aliphatic, including cycloaliphatic or aromatic organic residues, amongst which the aliphatic residues, i.e., linear or branched or cyclic aliphatic residues are preferred. Preferably the aliphatic, including cycloaliphatic or aromatic organic residues R^{m} are hydrocarbon residues. Even more preferred the monomeric organic residues R^{m} are aliphatic, including cycloaliphatic hydrocarbon residues.

Typical diisocyanates from which the two isocyanate groups are formally removed include 2,4-toluene diisocyanate, 2,6-toluene diisocyanate, diphenylmethane 4,4′-diisocyanate, diphenylmethane 2,4′-diisocyanate, p-phenylene diisocyanate, biphenyl diisocyanates, 3,3′-dimethyl-4,4′-diphenyl diisocyanate, tetramethylene 1,4-diisocyanate, hexamethylene 1,6-diisocyanate, 2,2,4-trimethylhexane 1,6-diisocyanate, isophorone diisocyanate (IPDI), ethylene diisocyanate, 1,12-dodecane diisocyanate, cyclobutane 1,3-diisocyanate, cyclohexane 1,3-diisocyanate, cyclohexane 1,4-diisocyanate, methylcyclohexyl diisocyanates, hexahydrotoluene 2,4-diisocyanate, hexahydrotoluene 2,6-diisocyanate hexahydrophenylene 1,3-diisocyanate, hexahydrophenylene 1,4-diisocyanate, perhydrodiphenylmethane 2,4′-diisocyanate, 1-isocyanato-4-[(4-isocyanatocyclohexyl)-methyl]-cyclohexane (H12-MDI; e.g., Desmodur® W from Covestro AG), tetramethylxylyl diisocyanates (e.g., TMXDI® from American Cyanamid), and mixtures of the aforementioned polyisocyanates.

If the organic residue R^{org} is an oligomeric organic residue R^{o}, it is preferably the residue of an oligomerization product of one or more diisocyanates from which after oligomerization the remaining isocyanate groups are formally removed, and the oligomerization product being selected from the group consisting of dimerization products, trimerization products, urethanization products, biuretization products and allophanatization products. Such oligomerization product comprises on average two or more free isocyanate groups and can be depicted as follows: R^{o}(NCO)ᵣ, with R^{o} being the oligomeric organic residue and r being 2.0 to 9.0, preferably r being 2.0 to 6.0, more preferred 2.3 to 4.0 and most preferred r being 2.5 to 3.5; R^{o} preferably comprises one or more groups selected from isocyanurate groups, iminooxadiazindion groups, urethane groups, biuret groups, uretdion groups and allophanate groups, most preferably it contains an isocyanurate group. The diisocyanates used to form such oligomerization products are the same as described in the previous section about monomeric organic residues R^{m}. Again, aliphatic and cycloaliphatic diisocyanates are preferred monomers used in oligomerization. Most preferred oligomeric organic residues R^{o} are formed from one or more of 1,6-hexamethylenediisocyanate, isophorone diisocyanate and H12-MDI. Particularly preferred oligomerization products are trimerization products formed from diisocyanates. Preferably, oligomeric crosslinking agents (B) are considered herein as polymers having a number-average molecular weight in the range from 300 to 3000 g/mol. The molecular weights of number average (Mₙ) and weight average (M_{w}) of crosslinking agents (B) or any other oligomeric or polymeric substances disclosed herein are determined by gel permeation chromatography (GPC) with tetrahydrofuran as an eluent using a polystyrene standard, ISO 13885-1: Measure according to 2008. A styrene-divinylbenzene copolymer is used as the column material. By this method, it is also possible to measure polydispersity (ratio of weight average molecular weight (M^{w}) to number average molecular weight (Mₙ)).

If the organic residue R^{org} is a polymeric organic residue R^{p}, it is preferably the residue of an isocyanate group containing polymer from which the isocyanate groups are formally removed. Such polymer can be depicted as follows: R^{p}—(NCO)ₛ, wherein R^{p} is a polymeric organic residue and s being 2.0 to 9.0, preferably 3.0 to 7.0 and more preferred s being 3.0 to 6.0. Preferably the polymeric organic residues R^{p} are linear or branched, aliphatic or aromatic, most preferred aliphatic. Most preferably the polymeric organic residues R^{p} contain one or more groups selected from polyurethane groups, polyester groups, polyether groups and polyacrylate groups.

Amongst residues R^{m}, R^{o} and R^{p}, residues R^{m} and R^{o} are most preferred.

### Groups R

### Alkoxysilane Groups Containing Groups of Formula (II)

At least one of groups R, preferably at least two of groups R in formula (I) are alkoxylsilane containing groups of formula (II)

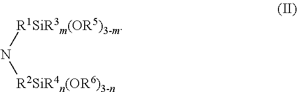

As already defined above, R¹ and R² are independently from each other selected from linear, branched and cyclic alkylene groups having 1 to 10 carbon atoms. Preferably the number of carbon atoms in R¹ and R² is 2 to 8, even more preferred 3 to 6 and most preferred 3, 4 and 5. Most preferably, R¹ and R² are linear alkylene groups having 3, 4 or 5, most preferably 3 carbon atoms, such as in (CH₂)₃ groups. In the present invention it is less preferred that R¹ and R² have only 1 carbon atom, since methylene groups typically lead to a higher reactivity and thus are less preferred with respect to storage stability of the one-pack coating material.

R³ and R⁴ are independently from each other selected from linear, branched and cyclic alkyl groups having 1 to 10 carbon atoms. Preferably the number of carbon atoms is 1 to 6, even more preferred 1 to 4 and most preferred 1, 2 or 3. Preferably R³ and R⁴ are selected from linear or branched alkyl groups.

R⁵ and R⁶ are independently selected from alkyl residues containing 2, 3 or 4 carbon atoms, preferably 2 or 3 and most preferred 2. The alkyl groups can be linear of branched. Preferably the alkyl groups are selected from ethyl, n-propyl, i-propyl, n-butyl, i-butyl and t-butyl, even more preferred from ethyl, n-propyl, i-propyl and t-butyl, most preferred R⁵ and R⁶ are ethyl. In the present invention it was found that the best-balanced properties regarding storage stability on the one hand and reactivity on the other hand were found for R⁵ and R⁶ being ethyl.

Residues OR⁵ and OR⁶ participate in the crosslinking reaction with the hydroxy-functional polymers (A) as well as in water- or moisture-induced self-crosslinking reactions as explained in more detail in the next paragraph. Generally, it can be stated that the reactivity of residues OR⁵ and OR⁶ in the crosslinking reactions decreases with an increasing number of carbon atoms in the residues R⁵ and R⁶. Thus, ethyl groups are more reactive than propyl groups, and propyl groups are more reactive than butyl groups.

The values for n and m are independently of each other 0, 1 or 2, preferably 0 or 1 and most preferred 0. The values for n and m determine the numbers of alkoxy groups bound to the silane. If m=0, formula (II) contains an Si(OR⁵)₃ group and if n=0, formula (II) contains an Si(OR⁶)₃ group. Preferably, at least one of n and m is 0. Even more preferred n and m are 0.

In the crosslinking reaction between the hydroxy groups of the at least one hydroxy-functional polymer (A) selected from the group consisting of poly(meth)acrylic polymers, polyesters, polyurethanes and polyethers and the crosslinking agents (B) the following reaction occurs: Si—OR^{5/6}+HO-Polymer→Si—O-Polymer+HO—R^{5/6}. This reaction is accompanied in the presence of water, preferably in form of moisture from the air, by a hydrolytic silane self-crosslinking reaction, which can be depicted as follows: 2 Si—OR^{5/6}+H₂O→Si—O—Si+2 HO—R^{5/6}, and which, in many cases is the predominant reaction.

The more Si—OR^{5/6} groups (i.e., Si—OR⁵ groups or Si—OR⁶ groups) are present in the crosslinking agent, the higher the crosslinking density with the hydroxy functional polymer (A) and the higher the self-crosslinking density, compared to compositions which are identical, except for having a higher value of the sum of n+m. Since preferably a high crosslinking density is desired n and m should be 0 or 1, more preferably n+m should be 0 or 1, most preferably n+m should be 0.

With respect to a balanced reactivity of the silane groups in the crosslinking agents (B), it is preferred that for each combination of residues R¹ with R⁵, and R² with R⁶, respectively, the sum of carbon atoms of both residues R¹ and R⁵, and R² and R⁶, respectively, is at least 4, more preferred 4 to 7, even more preferred 4 to 6 and most preferred 5. E.g., if R¹ is a propylene residue (3 carbon atoms), which is preferred, and each residue R⁵ is an ethyl group (2 carbon atoms), which is preferred, the sum of carbon atoms of each combination of R¹ and R⁵ is 3+2=5 carbon atoms.

### Alkoxysilane Groups Containing Groups of Formula (III)

R in formula (I) can also be an alkoxysilane containing group of formula (III)

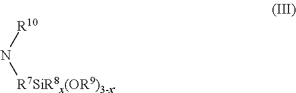

As already defined above, R⁷ is selected from linear, branched, and cyclic alkylene groups having 1 to 10, preferably 2 to 8, more preferred 3 to 6 and even more preferred 3, 4 or 5 carbon atoms and most preferred 3 carbon atoms, such as in (CH₂)₃ groups. Groups R⁸ are selected independently from each other from linear, branched, and cyclic alkyl groups having 1 to 10, preferably 1 to 6, more preferred 1 to 4 and most preferred 1, 2 or 3 carbon atoms. Groups R⁹ are independently selected from alkyl groups containing 2, 3 or 4, more preferred 2 or 3 and most preferred 2 carbon atoms. Group R¹⁰ is H or preferably an alkyl group containing 1 to 10, preferably 2 to 8, more preferred 4 to 6, and most preferred 4 carbon atoms. The value of x being 0, 1 or 2, preferably 0 or 1 and most preferred 0.

The considerations regarding the structure-reactivity relationships between the residues R¹, R², R³, R⁴, R⁵ and R⁶ and the reactivities of these residues themselves within groups R¹SiR³ₘ (OR⁵)₃₋ₘ and R²SiR⁴ₙ(OR⁶)₃₋ₙ as well as the corresponding values for n and m, are likewise valid for the residues R⁷, R⁸ and R⁹ and the value of x in groups R⁷SiR⁸ₓ(OR⁹)₃₋ₓ.

With respect to a balanced reactivity of the silane groups in the crosslinking agents (B), it is preferred that for each combination of residues R⁷ with R⁹ the sum of carbon atoms of both residues R⁷ and R⁹ is at least 4, more preferred 4 to 7, even more preferred 4 to 6 and most preferred 5. E.g., if R⁷ is a propylene residue (3 carbon atoms), which is preferred, and each residue R⁹ is an ethyl group (2 carbon atoms), which is preferred, the sum of carbon atoms of each combination of R⁷ and R⁹ is 3+2=5 carbon atoms.

### Isocyanate Blocking Groups R^{b}

Isocyanate blocking groups are groups which are formed or can be described by formally removing the active hydrogen from the corresponding isocyanate blocking agent H—R^{b}. Isocyanate blocking agents are compounds having an active hydrogen, which is apt to react with an isocyanate group (NCO group) under reversible formation of an —NH—(C═O)— group. At the crosslinking temperature of the coating material, which contains reactants comprising crosslinkable groups such as the hydroxy groups of the hydroxy functional polymer (A) deblocking of the blocked isocyanate group occurs, typically under release of the blocking agent.

Examples of suitable types or categories of blocking agents and also specific examples of such blocking agents include one or more of the following.

Blocking agents for preparing the fully blocked polyisocyanates are for example
i. phenols, pyridinols, thiophenols and mercaptopyridines, preferably selected from the group consisting of phenol, cresol, xylenol, nitrophenol, chlorophenol, ethylphenol, t-butylphenol, hydroxybenzoic acid, esters of this acid, 2,5-di-tert-butyl-4-hydroxytoluene, thiophenol, methylthiophenol and ethylthiophenol;
ii. alcohols and mercaptanes, the alcohols preferably being selected from the group consisting of methanol, ethanol, n-propanol, isopropanol, n-butanol, isobutanol, t-butanol, n-amyl alcohol, t-amyl alcohol, lauryl alcohol, ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, diethylene glycol monopropyl ether, diethylene glycol monobutyl ether, propylene glycol monomethyl ether, methoxy methanol, 2-(hydroxyethoxy)phenol, 2-(hydroxypropoxy)phenol, glycolic acid, glycolic esters, lactic acid, lactic esters, methylol urea, methylol melamine, diacetone alcohol, ethylene chlorohydrin, ethylene bromohydrin, 1,3-dichloro-2-propanol, 1,4-cyclohexyldimethanol or acetocyano hydrin, and the mercaptanes preferably being selected from the group consisting of butyl mercaptane, hexyl mercaptane, t-butyl mercaptan, t-dodecyl mercaptane;
iii. oximes, preferably the ketoximes of the groups consisting of the ketoxime of tetramethylcyclobutanedione, methyl n-amyl ketoxime, methyl isoamyl ketoxime, methyl 3-ethylheptyl ketoxime, methyl 2,4-dimethylpentyl ketoxime, methyl ethyl ketoxime, cyclohexanone oxime, methyl isopropyl ketoxime, methyl isobutyl ketoxime, diisobutyl ketoxime, methyl t-butyl ketoxime, diisopropyl ketoxime and the ketoxime of 2,2,6,6-tetramethylcyclohexanone; or the aldoximes, preferably from the group consisting of formaldoxime, acetaldoxime;
iv. amides, cyclic amides and imides, preferably selected from the group consisting of lactams, such as ε-caprolactam, δ-valerolactam, γ-butyrolactam or β-propiolactam; acid amides such as acetoanilide, acetoanisidinamide, acrylamide, methacrylamide, acetamide, stearamide or benzamide; and imides such as succinimide, phthalimide or maleimide;
v. imidazoles and amidines;
vi. pyrazoles and 1,2,4-triazoles, such as 3,5-dimethylpyrazole and 1,2,4-triazole;
vii. amines and imines such as diphenylamine, phenylnaphthylamine, xylidine, N-phenylxylidine, carbazole, aniline, naphthylamine, butylamine, dibutylamine, butylphenylamine and ethyleneimine;
viii. imidazoles such as imidazole or 2-ethylimidazole;
ix. ureas such as urea, thiourea, ethyleneurea, ethylenethiourea or 1,3-diphenylurea;
x. active methylene compounds such as dialkyl malonates like diethyl malonate, and acetoacetic esters; and
xi. others such as hydroxamic esters as for example benzyl methacrylohydroxamate (BMH) or allyl methacrylohydroxamate, and carbamates such as phenyl N-phenylcarbamate or 2-oxazolidone.

Amongst the above blocking agents, the oximes (group iii.), particularly methyl ethyl ketoxime and the pyrazoles (group vi.), particularly 3,5-dimethylpyrazole are most preferred.

The blocking agents of group x. do not react in a deblocking reaction at elevated temperature, but in a transesterification of the ester groups present therein, when reacted with alcohols, particularly polyols.

Further blocking agents and their mechanisms of action, kinetics as well as catalysis are, e.g., described in the Review Paper from D. A. Wicks and Z. W. Wicks with the title “Blocked isocyanates III: Part A. Mechanisms and chemistry” in Progress in Organic Coatings 36 (1999), 148-172.

### Contents and Ratios of Different R Groups

The crosslinking agent (B) of general formula (I)

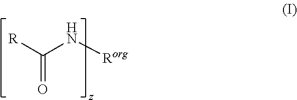

wherein R, R^{org} and z are defined above contains at least two groups R(C═O)NH, i.e., z is at least 2

If z=2 in the crosslinking agent (B), it is preferred that both residues R are residues of formula (II). This is, e.g., the case if a monomeric diisocyanate such as H12-MDI is used as R^{m} (NCO)₂.

If on average more than two (z>2), such as three or more (z≥3) residues of formula (I) are comprised in the crosslinking agent (B), it is preferred that on average a part of residues R are residues of formula (II) and that on average at least a part of the R residues are blocking groups R^{b}.

As already explained above, crosslinking agents (B) are herein considered as substances comprising a plurality of molecules which do not necessarily have to be identical. Thus, if mole percentages and mole percentage ranges regarding residues R are used to describe the amounts and types of R groups in the crosslinking agents (B) those mole percentages are averages over the plurality of molecules contained therein.

In a hypothetical example, the crosslinking agent (B) consists of a mixture of exactly two types of molecules in a 50:50 molar ratio. The first type of molecule is based on an isocyanurate of HDI wherein 2 of 3 NCO groups were reacted to introduce a specific group of formula (II) and the remaining one of the 3 NCO groups was reacted to introduce a dimethylpyrazole blocking group. The second type of molecule is an isocyanurate of HDI wherein 1 of 3 NCO groups was reacted to introduce the very same specific group of formula (II) as was introduced in the first type of molecule and the remaining 2 of 3 NCO groups were reacted to introduce dimethylpyrazole blocking groups. On a molecular level, in the first type of molecules 66.7 mole-% of specific groups of formula (II), and 33.3 mole-% of dimethylpyrazole blocking groups are contained, while in the second type of molecules 33.3 mole-% of specific groups of formula (II), and 66.7 mole-% of dimethylpyrazole blocking groups are contained. However, in this hypothetical example, on average 50 mole-% of groups of formula (I) in the crosslinking agent (B) contain the specific group of formula (II) as residues R and on average 50 mole-% of groups of formula (I) in the crosslinking agent (B) contain a dimethylpyrazole group as residues R. In other words, since an ideal isocyanurate contains 3 groups of formula (I), on average 1.5 of the three groups of formula (I) contain the specific group of formula (II) as residue R and on average 1.5 of the three groups of formula (I) contain a dimethylpyrazole blocking group as residue R.

Consequently, in relation to the crosslinking agent (B) as a substance, different ranges of molar ratios of the different R groups can be accomplished, depending on the molar ratios of the starting compounds used to introduce the groups of formulae (II) and (III) and the isocyanate blocking groups.

Preferably the molar percentage ranges of the entirety of residues R in the crosslinking agent (B) are as follows:
15 to 100 mole-% of the entirety of residues R are residues of formula (II);
0 to 50 mole-% of the entirety of residues R are residues of formula (III); and
0 to 85 mole-% of the entirety of residues R are isocyanate blocking groups.

More preferred the molar percentage ranges of the entirety of residues R in the crosslinking agent (B) are as follows:
20 to 100 mole-% of the entirety of residues R are residues of formula (II);
0 to 20 mole-% of the entirety of residues R are residues of formula (III); and
0 to 80 mole-% of the entirety of residues R are isocyanate blocking groups.

Even more preferred the molar percentage ranges of the entirety of residues R in the crosslinking agent (B) are as follows:
30 to 100 mole-% of the entirety of residues R are residues of formula (II);
0 to 10 mole-% of the entirety of residues R are residues of formula (III); and
0 to 70 mole-% of the entirety of residues R are isocyanate blocking groups.

Most preferred the molar percentage ranges of the entirety of residues R in the crosslinking agent (B) are as follows:
40 to 100 mole-% of the entirety of residues R are residues of formula (II);
0 to 5 mole-%, preferably 0 mole-% of the entirety of residues R are residues of formula (III); and
0 to 60 mole-% of the entirety of residues R are isocyanate blocking groups.

It was further found that in case R^{org} is a residue which contains one or more cycloaliphatic moieties of cycloaliphatic moiety containing diisocyanates, such as present in IPDI and H12-MDI, it is preferred that the molar percentage ranges of the entirety of residues R in the crosslinking agent (B) are as follows:
20 to 100 mole-%, more preferred 60 to 100 mole-% of the entirety of residues R are residues of formula (II);
0 to 10 mole-%, more preferred 0 to 5 mole-%, such as 0 mole-% of the entirety of residues R are residues of formula (III); and
0 to 80 mole-%, more preferred 0 to 40 mole-% of the entirety of residues R are isocyanate blocking groups.

On the other hand, in case R^{org} contains no cycloaliphatic moieties of cycloaliphatic moiety containing diisocyanates, but linear aliphatic moieties of linear aliphatic moiety containing diisocyanates, such as present in HDI, it is preferred that the molar percentage ranges of the entirety of residues R in the crosslinking agent (B) are as follows:
20 to 90 mole-%, more preferred 50 to 80 mole-% of the entirety of residues R are residues of formula (II);
0 to 10 mole-%, more preferred 0 to 5 mole-%, such as 0 mole-% of the entirety of residues R are residues of formula (III); and
10 to 80 mole-%, more preferred 20 to 50 mole-% of the entirety of residues R are isocyanate blocking groups.

Typically, in all embodiments the presence of groups of formula (III) is less desirable, because compared to groups of formula (II) their contribution to the network density in the resulting cured coating is less.

### Preparation of Crosslinking Agent (B)

Crosslinking Agent (B) is preferably prepared by reacting a diisocyanate R^{m}(NCO)₂, an oligomeric di- or polyisocyanate R^{o}(NCO)ᵣ or a polymeric di- or polyisocyanates R^{p}(NCO)ₛ, wherein R^{m}, R^{o}, R^{p}, s and r are defined as above, with
i. at least one secondary amine of formula (IIa):

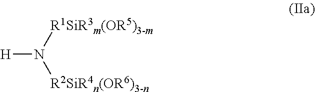

wherein R¹, R², R³, R⁴, R⁵, R⁶, m and n are defined as above;
and in case that not all of groups R in formula (I) are groups of formula (II), additionally with
ii. at least one amine of formula (IIIa):

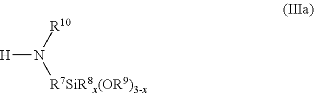

wherein R⁷, R⁸, R⁹, R¹⁰ and x are defined as above; and/or
iii. at least one isocyanate blocking agent H—R^{b} as defined above;
with the proviso that on average at least 15 mole-% of the entirety of the NCO groups in the diisocyanates and polyisocyanates are reacted with compounds of formula (IIa).

Examples of secondary amines (IIa) are, e.g., bis(2-ethyltriethoxysilyl) amine, bis(3-propyltriethoxysilyl) amine and/or bis(4-butyltriethoxysilyl) amine. Very particular preference is given to bis(3-propyltriethoxysilyl) amine. Aminosilanes of this kind are available, for example, under the brand name DYNASYLAN® from Evonik or Silquest® from Momentive.

Examples of amines (IIIa) are, e.g., 2-aminoethyltriethoxysilane, 3-aminopropyltriethoxysilane, 4-aminobutyltriethoxysilane. Particularly preferred compounds (IIIa) are N-(2-(triethoxysilyl)ethyl)alkylamines, N-(3-(triethoxysilyl)-propyl)alkylamines and/or N-(4-(triethoxysilyl)butyl)alkylamines. Particularly preferred amino silanes of formula (IIIa) are gamma-amino silanes. Aminosilanes of this kind are available, for example, under the brand name DYNASYLAN® from Evonik or Silquest® from Momentive.

Preferably, the above reaction is carried out without solvent or in the presence of an aprotic organic solvent wherein the ingredients are soluble. Even more preferred such solvents are selected from hydrocarbons such as Solvent Naphtha, esters such as butyl acetate or methoxypropylacetate and ketones such as methyl ethyl ketone.

Preferably, a solution of the respective isocyanate R^{m} (NCO)₂, R^{o}(NCO)ᵣ or R^{p}(NCO)ₛ is provided and the one or more secondary amines of formula (IIa) and optionally one or more of amines of formula (IIIa) and/or the one or more isocyanate blocking agents are added. The sequence of adding the amines and blocking agents is not critical. They can be added one after the other or simultaneously.

The reaction is preferably carried out at a temperature of not more than 100° C., more preferably 30 to 80° C. and even more preferred 35 to 60° C., and most preferred 40 to 50° C. Even more preferably the reaction is carried out under an inert gas atmosphere such as a nitrogen atmosphere, while agitating.

The secondary amine of formula (IIa), and the optional amine of formula (IIIa) and/or isocyanate blocking agent are preferably employed in the reaction with the respective isocyanate or isocyanate mixtures in a stochiometric amount allowing conversion of all isocyanate groups originally present in the isocyanate, which is employed in the reaction.

The molar percentages of the different groups R can be easily adjusted by employing the respective molar amounts of the amines and isocyanate blocking agents based on a 100 mole-% conversion of the original isocyanate groups contained in the isocyanate group containing starting compounds.

Since the crosslinking agent (B) is used in a storage stable one-pack coating material, it is clear for one of skill in the art that the reaction is carried out until all available isocyanate groups have reacted with the secondary amine of formula (IIa), and the optional amine of formula (IIIa) and/or isocyanate blocking agent. The conversion rate (i.e., the progress of the reaction between the isocyanate groups and the isocyanate reactive groups) can be monitored by determination of the remaining NCO content as described in detail in the experimental section of the present invention. The crosslinking agent (B) preferably comprises a content of free isocyanate groups of less than 1.0 wt.-%, more preferably 0.5 wt.-%, more preferably of 0 to 0.05%. This ensures that the crosslinking agent is essentially free of NCO groups, thus allowing to use this compound in isocyanate-free coating materials.

### Aprotic Organic Solvents (C)

The coating material of the present invention comprises at least one aprotic organic solvent. Amongst these, polar aprotic organic solvents, but also aromatic solvents can be employed.

### Polar Aprotic Organic Solvents (C1)

Amongst useful polar aprotic solvents preferred solvents are ketones, esters, acetates, aprotic amides, aprotic sulfoxides, and aprotic amines. Examples of specific useful solvents include ketones, such as acetone, methyl ethyl ketone, methyl amyl ketone and methyl isobutyl ketone; esters such as ethyl acetate, butyl acetate, pentyl acetate, ethyl ethoxypropionate, ethylene glycol butyl ether acetate and propylene glycol monomethyl ether acetate; ethers such as glycol diethers; alkoxyalkanoles, such as methoxypropanol; nitrogen-containing compounds such as N-methyl pyrrolidone and N-ethyl pyrrolidone.

### Non-Polar Aprotic Organic Solvents (C2)

Amongst the useful non-polar aprotic solvents preferred are aliphatic and/or aromatic hydrocarbons such as toluene, xylene, solvent naphtha, and mineral spirits.

One or more of the polar aprotic organic solvents and/or one or more of the non-polar organic solvents can be contained in the coating materials of the present invention.

### Optional Crosslinking Agents (D)

The one-pack coating of the invention preferably contains at least one additional crosslinking agent (B) reactive with hydroxyl groups, besides the crosslinking agent (B). Such further crosslinking agents are preferably selected from the group of (D1) blocked di- or polyisocyanates, which do not contain hydrolysable silane groups and (D2) aminoplast resins.

Blocked Diisocyanates and/or Polyisocyanates, which do not Contain Hydrolysable Silane Groups (D1)

Suitable blocked diisocyanates and/or blocked polyisocyanates, which do not contain hydrolysable silane groups (D1) are defined identical to the crosslinking agents (B), with the exception that none of residues R are residues of formulae (II) or (III) and that all residues R are residues R^{b}, i.e., residues of isocyanate blocking agents H—R^{b}.

### Aminoplast Resins (D2)

Preferred crosslinkers for one-pack coating materials are aminoplast resins having active methylol, methylalkoxy or butylalkoxy groups and blocked polyisocyanate crosslinkers, which could be reactive with the hydroxyl groups.

Aminoplasts, also referred to as amino resins, are described in Encyclopedia of Polymer Science and Technology vol. 1, p. 752-789 (1985). An aminoplast is obtained by reaction of an activated nitrogen with a lower molecular weight aldehyde, optionally with further reaction with an alcohol (preferably a mono-alcohol with one to four carbon atoms such as methanol, isopropanol, n-butanol, isobutanol, etc.) to form an ether group. Preferred examples of activated nitrogens are activated amines such as melamine, benzoguanamine, cyclohexylcarboguanamine, and acetoguanamine; ureas, including urea itself, thiourea, ethylene urea, dihydroxyethylene urea, and guanyl urea; glycoluril; amides, such as dicyandiamide; and carbamate-functional compounds having at least one primary carbamate group or at least two secondary carbamate groups. The activated nitrogen is reacted with a lower molecular weight aldehyde. The aldehyde may be selected from formaldehyde, acetaldehyde, crotonaldehyde, benzaldehyde, or other aldehydes used in making aminoplast resins, although formaldehyde and acetaldehyde, especially formaldehyde, are preferred. The activated nitrogen groups are at least partially alkylolated with the aldehyde, and may be fully alkylolated. The reaction may be catalyzed by an acid, e.g., as taught in U.S. Pat. No. 3,082,180.

The optional alkylol groups formed by the reaction of the activated nitrogen with aldehyde may be partially or fully etherified with one or more monofunctional alcohols. Suitable examples of the monofunctional alcohols include, without limitation, methanol, ethanol, n-propanol, isopropanol, n-butanol, isobutanol, tert-butyl alcohol, benzyl alcohol, and so on. Monofunctional alcohols having one to four carbon atoms and mixtures of these are preferred. The etherification may be carried out, for example, the processes disclosed in U.S. Pat. Nos. 4,105,708 and 4,293,692. The aminoplast may be at least partially etherified, but can be fully etherified. For example, the aminoplast compounds may have a plurality of methylol and/or etherified methylol, butylol, or alkylol groups, which may be present in any combination and along with unsubstituted nitrogen hydrogens. Examples of suitable curing agent compounds include, without limitation, melamine formaldehyde resins, including monomeric or polymeric melamine resins and partially or fully alkylated melamine resins, and urea resins (e.g., methylol ureas such as urea formaldehyde resin, and alkoxy ureas such as butylated urea formaldehyde resin). One example of a fully etherified melamine-formaldehyde resin is hexamethoxymethyl melamine.

The alkylol groups are capable of self-reaction to form oligomeric and polymeric aminoplast crosslinking agents. Useful materials are characterized by a degree of polymerization. For melamine formaldehyde resins, it is preferred to use resins having a number average molecular weight less than about 2000 g/mol, more preferably less than 1500 g/mol, and even more preferably less than 1000 g/mol.

In the present invention it is preferred that the coating material of the invention contains one or more crosslinking agents (D), most preferred at least one crosslinking agent (D1) and/or at least one crosslinking agent (D2).

### Catalysts (E)

The coating materials of the invention preferably comprise one or more catalysts to catalyze the crosslinking reactions in the coating material.

### Acidic Catalysts

Such catalysts are well known in the art and include, for example, sulfonic acids such as para-toluenesulfonic acid, dinonylnaphthalene disulfonic acid, dodecylbenzene-sulfonic acid, phenyl acid phosphate, monobutyl maleate, butyl phosphate, and hydroxy phosphate ester. Such (strong) acid catalysts, which are preferred in the present invention, are often blocked, preferably ionically blocked, e.g., with an amine.

### Organometallic Catalysts

Further catalysts are for example organotin catalysts and bismuth-based catalysts. Amongst the organotin catalysts dialkyltin dicarboxylates such as dibutyltin dilaurate or dioctyltin dilaurate are preferred. However, it is preferred that no organotin catalysts are contained in the one-pack coating material of the invention in an amount that catalyzes the crosslinking reaction of one-pack coating material, and it is even further preferred that no tin containing catalysts are contained in the one-pack coating materials of the present invention in an amount that catalyzes the crosslinking reaction of one-pack coating material. Most preferred no organotin catalysts and even more preferred no tin catalysts are contained in the one-pack coating material. Amongst the bismuth-based catalysts bismuth carboxylates such as bismuth neodecanoate or bismuth ethylhexanoate are preferred.

### Colorants (F)

The term “colorants” encompasses colorants which are soluble in the coating material of the invention, i.e., dyes; and colorants which are insoluble in the coating material of the invention, i.e., pigments (and fillers). To achieve the aim of the present invention a distinction between pigments and fillers is not necessary. However, generally fillers differ from the pigments by a diffractive index of less than 1.7.

Suitable pigments can be organic or inorganic pigments. Typical organic pigments are, e.g., Pigment Blue 15, Pigment Violet 29, Pigment Red 202, Pigment Red 179 and Pigment Brown 25, and typical inorganic pigments are, e.g., carbon black, titanium dioxide and iron oxide.

It is preferred that the coating materials of the invention do not contain pigments, thus are pigment free, particularly pigment free and filler free, particularly in case the coating material of the present invention is a clearcoat material.

However, in some cases it is desired that such coating material, even a clearcoat material provides a coloristic effect. In such cases transparent pigments or any pigments in tinting amount may be employed in the coating material. A “tinting amount” is an amount which does not allow the coating layer formed from the coating material to become opaque. Generally tinting amounts depend on the type of the colorant. Generally, suitable tinting amounts of pigments and/or fillers range from 0.01 to 5 wt.-%, more preferred 0.1 to 2 wt.-% and most preferred from 0.5 to 1 wt.-%, based on the total weight of the coating material.

### Coatings Additives (G)

Additionally, customary coating additives (G) may be included, for example, surfactants, stabilizers, dispersing agents, adhesion promoters, UV absorbers, hindered amine light stabilizers such as HALS compounds, benzotriazoles or oxalanilides; free-radical scavengers; slip additives; defoamers (de-aerating additives); reactive diluents, of the kind which are common knowledge from the prior art; wetting agents such as siloxanes, fluorine compounds, carboxylic monoesters, phosphoric esters, polyacrylic acids and their copolymers, for example polybutyl acrylate, or polyurethanes; adhesion promoters such as tricyclodecanedimethanol; flow control agents; film-forming assistants such as cellulose derivatives; rheology control additives; inorganic phyllosilicates such as aluminum-magnesium silicates, sodium-magnesium and sodium-magnesium-fluorine-lithium phyllosilicates of the montmorillonite type; silicas such as Aerosil®; or synthetic polymers containing ionic and/or associative groups such as polyvinyl alcohol, poly(meth)acrylamide, poly(meth)acrylic acid, polyvinylpyrrolidone, styrene-maleic anhydride copolymers or ethylene-maleic anhydride copolymers and their derivatives, or hydrophobically modified ethoxylated urethanes or polyacrylates; flame retardant; and so on. Typical coating materials include one or a combination of such additives.

### Further Solvents (H)

The coating material of the present invention may further contain protic solvents. Such protic solvents should however be selected to be virtually inert to the other ingredients contained in the coating material, particularly inert towards the crosslinking agent (B). Typically, such protic solvents might be alcohols such as butanol or the like.

### Amounts of Ingredients (A) to (H) in the Coating Material of the Invention

The one-pack coating material of the present invention, preferably comprises:
10 to 50 wt.-%, more preferred 15 to 40 wt.-% and even more preferred 18 to 35 wt.-% of the one or more hydroxy-functional polymers (A);
2.0 to 30 wt.-%, more preferred 2.0 to 25 wt.-% and even more preferred 2.0 to 20 wt.-% of the one or more crosslinking agents (B);
15 wt.-% to 65 wt.-%, more preferred 20 wt.-% to 60 wt.-%, even more preferred 25 wt.-% to 58 wt.-% and most preferred 28 to 55 wt.-% of the one or more aprotic organic solvent (C);
0 to 10 wt.-%, more preferred 1 to 7.5 wt.-% and even more preferred 1.5 to 5 wt.-% of the one or more blocked diisocyanates and/or the one or more blocked polyisocyanates (D1), which do not contain hydrolysable silane groups;
0 to 30 wt.-%, more preferred 5 to 25 wt.-% and even more preferred 9 to 20 wt.-% of the one or more aminoplast resins (D2);
0 to 2 wt.-%, more preferred 0.25 to 1.5 wt.-% and most preferred 0.4 to 1 wt.-% of the one or more catalysts (E);
0 to 5 wt.-%, more preferred 0 to 2 wt.-% and even more preferred 0 to 1 wt.-% of the one or more colorants (F);
0 to 15 wt.-% of the one or more coatings additives (G), and if the one or more coatings additives are selected from the group consisting of light stabilizers, UV absorbers, levelling additives, de-aerating additives and dispersing additives more preferably 0 to 10 wt.-%, even more preferred 0 to 5 wt.-% and most preferred 1 to 3 wt.-%; and
0 to 20 wt.-%, more preferred 3 to 15 wt.-% and most preferred 4 to 10 wt.-% of the one or more further protic solvents (H);
all weight-percentages (wt.-%) being based on the total weight of the one-pack coating material, which preferably is a clear coat material.

The above ranges also apply for the preferred embodiments.

It is particularly preferred, that the one-pack coating material, based on the total weight of the one-pack coating material, contains 2.0 to 30 wt.-% of the one or more crosslinking agents (B) and one or more aminoplast resins (D2). Even more preferred the one-pack coating material, based on the total weight of the one-pack coating material, contains 2.0 to 25 wt.-% of the one or more crosslinking agents (B) and 5 to 25 wt.-% of the one or more aminoplast resins (D2). Further preferred, the one-pack coating material, based on the total weight of the one-pack coating material, contains 2.0 to 20 wt.-% of the one or more crosslinking agents (B) and 9 to 20 wt.-% of the one or more aminoplast resins (D2).

Particularly preferred, any of the one-pack coating materials, and even more preferred those one-pack coating materials mentioned in the preceding paragraph contain protic solvents (H), preferably in an amount of up to 20 wt.-%, more preferred in an amount of 3 to 15 wt.-% and most preferred in an amount of 4 to 10 wt.-% based on the total weight of the one-pack coating material. Most preferred protic solvents are alcohols, amongst which alkanols, containing 2 to 6 carbon atoms are most preferred. Such alcohols are most preferred monoalkanols. Examples of such monoalkanols are ethanol, n- and i-propanol, n-, i- and t-butanol, linear or branched pentanol and linear or branched hexanol.

The total solids content of the coating material of the invention preferably ranges from 30 to 70 wt.-%, more preferably from 40 to 60 wt.-% and most preferred from 41 to 55 wt.-% based on the total weight of the coating composition. The solids content being determined as described in the experimental section of the present invention.

Method of Coating a Substrate and an accordingly Coated Substrate

Accordingly, a further object of the present invention is a method of forming a coating on a substrate(S) with the coating materials according to the invention, the method comprising the following steps:
(1) applying a coating material of the invention onto the substrate(S);
(2) forming a coating film from the coating material applied in step (1); and
(3) curing the coating film formed in step (2).

Further object of the present invention are coated substrates, which are obtainable by the method according to the invention.

The coating materials of the invention can be coated by any of several techniques well known in the art. These include, for example, spray coating, dip coating, roll coating, curtain coating, knife coating, spreading, pouring, dipping, impregnating, trickling or rolling, and the like. For automotive body panels, spray coating is typically used. Preference is given to employing spray application methods, such as compressed-air spraying, airless spraying, high-speed rotation, electrostatic spray application, alone or in conjunction with hot spray application such as hot-air spraying, for example.

The coating materials and coating systems of the invention are employed in particular in the technologically and esthetically particularly demanding field of automotive OEM finishing. The coating materials can be used in both single-stage and multistage coating methods.

The applied coating materials can be cured after a certain rest time or “flash” period. The rest time serves, for example, for the leveling and devolatilization of the coating films or for the evaporation of volatile constituents such as solvents. The rest time may be assisted or shortened by the application of elevated temperatures or by a reduced humidity, provided this does not entail any damage or alteration to the coating films, such as premature crosslinking, for instance.

The thermal curing of the coating materials has no peculiarities in terms of method but instead takes place in accordance with the typical, known methods such as heating in a forced-air oven or irradiation with IR lamps. The thermal cure may also take place in stages. Another preferred curing method is that of curing with near infrared (NIR) radiation.

Generally, heat curing is affected by exposing the coated article to elevated temperatures provided primarily by radiative heat sources. After application, the applied coating layer is cured, for example with heat at temperatures from above 100° C. to 200° C., or from 110 to 190° C., or from 120 to 180° C., for a time of 5 min up to 30 min, and more preferably 10 min up to 25 min. The curing temperatures are understood as the temperatures surrounding the coating layer to be cured, and thus not necessarily the temperature of the substrate or the coating layer to be cured.

Film thicknesses (i.e., layer thicknesses) as described herein relate to dry layer film thicknesses, i.e., the layer thickness of the cured layer/film. The layer thicknesses of the cured layers of the coating material according to the present invention formed on substrates are as follows. Cured primer layers, if applied, formed from the coating material of the present invention typically have thicknesses of from about 12 μm to about 25 μm. Cured filler layers, if applied, formed from the coating material of the present invention typically have thicknesses of from about 10 μm to about 40 μm. Cured base coat layers, if applied, formed from the coating material of the present invention typically have a thickness of from about 10 to about 25 μm. Cured clear coat layers, if applied, formed from the coating material of the present invention typically have a thickness of from about 20 to about 50 μm.

Preferably the substrate materials are chosen from the group consisting of metals, polymers, wood, glass, mineral-based materials, and composites of any of the afore-mentioned materials.

The term metal comprises metallic elements like iron, aluminum, zinc, copper and the like as well as alloys such as steel like bare steel, cold-rolled steel, galvanized steel and the like. Polymers can be thermoplastic, duroplastic or elastomeric polymers, duroplastic and thermoplastic polymers being preferred. Mineral-based materials encompass materials such as e.g., hardened cement and concrete. Composite materials are e.g., fiber-reinforced polymers etc.

Of course, it is possible to use pre-treated substrates, where the pre-treatment regularly depends on the chemical nature of the substrate.

Preferably, the substrates are cleaned before use, e.g., to remove dust, fats, oils, or other substances which typically prevent a good adhesion of coatings. The substrate can further be treated with adhesion promoters to increase the adhesion of subsequent coatings.

Metallic substrates may comprise a so-called conversion coat layer and/or electrodeposition coat layer before being coated with the coating material according to the present invention. This is particularly the case for substrates in the automotive coating field such as automotive OEM and automotive refinish coating.

The electrodeposition composition used to form the electrodeposition coat layer can be any electrodeposition composition used in automotive vehicle coating operations. Non-limiting examples of electrocoat compositions include electrocoating materials sold by BASF. Electrodeposition coating baths usually comprise an aqueous dispersion or emulsion including a principal film-forming epoxy resin having ionic stabilization (e.g., salted amine groups) in water or a mixture of water and organic cosolvent. Emulsified with the principal film-forming resin is a crosslinking agent that can react with functional groups on the principal resin under appropriate conditions, such as with the application of heat, and so cure the coating. Suitable examples of crosslinking agents include, without limitation, blocked polyisocyanates. The electrodeposition coating materials usually include one or more pigments, catalysts, plasticizers, coalescing aids, antifoaming aids, flow control agents, wetting agents, surfactants, UV absorbers, HALS compounds, antioxidants, and other additives.

The electrodeposition coating material is preferably applied to a dry film thickness of 10 to 25 μm. After application, the coated vehicle body is removed from the bath and rinsed with deionized water. The coating may be cured under appropriate conditions, for example by baking at from about 135° C. to about 190° C. for preferably about 15 to about 60 minutes.

For polymeric substrates pretreatment may include, for example, treatment with fluorine, or a plasma, corona, or flame treatment. Often the surface is also sanded and/or polished. The cleaning can also be done manually by wiping with solvents with or without previous grinding or by means of common automated procedures, such as carbon dioxide cleaning.

Any of the above substrates can also be pre-coated with one or more fillers and/or one or more base coats prior to the formation of the coating layer. Such fillers and base coats may contain color pigments and/or effect pigments such as metallic effect pigments as, e.g., aluminum pigments; or pearlescent pigments as, e.g., mica pigments. This is particularly the case for substrates in the automotive coating field such as automotive OEM and automotive refinish coating.

Depending on the substrate material chosen, the coating materials can be applied in a wide variety of different application areas. Many kinds of substrates can be coated. The coating materials of the invention are therefore outstandingly suitable for use as decorative and protective coating systems, particularly for bodies of means of transport (especially motor vehicles, such as motorcycles, buses, trucks or automobiles) or parts thereof. The substrates preferably comprise a multilayer coating as used in automotive coating.

The coating materials of the invention are also suitable for use on constructions, interior and exterior; on furniture, windows, and doors; on plastics moldings, especially CDs and windows; on small industrial parts, on coils, containers, and packaging; on white goods; on sheets; on optical, electrical, and mechanical components, and on hollow glassware and articles of everyday use.

Accordingly, a further object of the present invention is a substrate coated according to the inventive method of coating.

### Multilayer Coatings and Multilayer-Coated Substrates

Yet another object of the present invention is a multilayer coating, consisting of at least two coating layers, at least one of which is formed from a coating material according to the present invention. Typically, the multilayer coating comprises more than two coating layers.

A preferred multilayer coating comprises at least one pigment and/or filler containing layer, such as a primer coat layer, filler coat layer or a base coat layer; and at least one clear coat layer. The coating materials of the present invention preferably form the clear coat layer.

Even more preferred is a multilayer coating comprising at least one filler coat layer, coated with at least one base coat layer, which again is coated with at least one clear coat layer.

Particularly, but not limited to automotive coating a multilayer coating preferably comprises an electro coat layer, at least one filler coat layer on top of the electro coat layer, coated with at least one base coat layer, which again is coated with at least one clear coat layer.

The above multilayer coatings can be applied to any of the substrates named above, typically, but not limited to pretreated substrates. Therefore, another object of the present invention is a multilayer-coated substrate, coated with any of the above multilayer coatings, the multilayer coating, preferably being cured.

In the following the invention is further described by mean of examples.

### EXAMPLES

The present invention will now be explained in greater detail by working examples, but the present invention is in no way limited to these working examples. Moreover, the terms “parts”, “%” and “ratio” in the examples denote “parts by mass”, “mass %” and “mass ratio” respectively unless otherwise indicated.

### Analytical Methods

### Solids Content (Solids, Nonvolatile Fraction)

The nonvolatile fraction is determined according to DIN EN ISO 3251 (date: June 2008). It involves weighing out 1 g of sample into an aluminum dish which has been dried beforehand, drying it in a drying oven at 130° C. for 60 minutes, cooling it in a desiccator and then reweighing it. The residue relative to the total amount of sample used corresponds to the nonvolatile fraction.

### Isocyanate Content (NCO Content)

The isocyanate content was determined by adding an excess of a 2% N, N-dibutylamine solution in xylene to a homogeneous solution of the sample in acetone/N-ethyl pyrrolidone (1:1 vol %), by potentiometric back-titration of the amine excess with 0.1 N hydrochloric acid, in a method based on DIN EN ISO 3251:2008-06, DIN EN ISO 11909:2007-05, and DIN EN ISO 14896:2009-07. The NCO content of the silane-based compound R, based on solids, can be calculated via the fraction of the polymer (solids content) in solution.

### Viscosity

The viscosity was determined by the withdrawn standard DIN 53211:1974-04 by measurement of the flow time (in seconds) by means of a DIN 4 Cup at a temperature of 23° C.

### Testing Methods

### Scratch Resistance

Scratch resistance of the coating layer was determined using a linear abrasion tester (crockmeter) according DIN 55654:2015-08. This standard specifies a procedure for determining the resistance of a coating to scratching caused by a linearly moving scratching material loaded over its entire surface. The process can also be applied to other material surfaces such as plastics, coatings, and metals. With a linear lifting device (crockmeter), a loaded friction pin covered with agreed scratch material (P2400 abrasive paper) was moved over the coating under the influence of an agreed scratch medium. In the motor version, a preselection counter for the double stroke number must be integrated and the drive must be designed so that the stroke frequency is (1.0±0.1) Hz. Ten (10) double strokes were carried out. The evaluation of the scratch mark was done directly by measuring the residual gloss at 60° using a standard commercial gloss meter. Four panels of each multilayer-coated substrate were prepared, and each substrate was tested at two positions. An average value was calculated from these eight measurements. The average value was than corrected by a PMMA reference, which was tested in the same manner. Ideally the gloss loss of this reference is 20, but it has to be in the range of 15 to 25. If the reference gloss loss was between 20 and 25, the difference of the measured gloss loss and 20 had to be subtracted from the calculated average value of the multilayer-coated substrates. If the gloss loss was between 15 and 20, the difference of the measured gloss loss and 15 had to be added to the calculated mean value of the multi-layer coated substrates.

### Preparation of Different Silane-Modified and Optionally 3,5-Dimethylpyrazole Blocked Polyisocyanates

Different silane-modified and optionally 3,5-dimethylpyrazole blocked polyisocyanates were prepared according to the following general procedure using the amounts listed in Table 1 below:

In a reaction vessel a polyisocyanate selected from hexamethyl 1,6-diisocyanate (HDI) trimer (Desmodur® N3300), 4,4′-diisocyanato dicyclohexylmethane (H12-MDI) (Desmodur W), or isophorone diisocyanate (IPDI) trimer (Vestanat) and solvents (solvent naptha, methoxypopyl acetate, butyl acetate, methylethyl ketone) are introduced. With reflux cooling, nitrogen blanketing and stirring, bis(3-triethoxysilylpropyl)amine (Dynasylan® 1122) and optionally 3,5-dimethylpyrrazole (DMP) are added dropwise at a rate such that a temperature of 50-60° C. is not exceeded in a stochiometric ratio allowing conversion of all isocyanate groups originally present in the isocyanate source compound until the remaining NCO content reached a value <1%, determined by means of titration as described above.

TABLE 1

| | Examples (E1 to E7) and | | | | | | |
|---|---|---|---|---|---|---|---|
| | Comparative Example (CE 1) | | | | | | |
| Ingredients | E1 | E2 | E3 | E4 | E5 | E6 | E7 |
| HDI trimer | 23.23 | 31.70 | 38.77 | 40.58 | 0 | 0 | 0 |
| IPDI trimer | 0 | 0 | 0 | 0 | 38.68 | 44.98 | 0 |
| H12-MDI | 0 | 0 | 0 | 0 | 0 | 0 | 12.68 |
| Dynasylan ® 1122 | 51.77 | 35.33 | 21.60 | 18.09 | 27.13 | 15.77 | 41.21 |
| 3,5-Dimethylpyrazole | 0 | 7.98 | 14.63 | 16.34 | 9.19 | 14.25 | 0 |
| Solventnaptha | 13.75 | 13.75 | 13.75 | 13.75 | 13.75 | 13.75 | 0 |
| Methoxypropyl | 11.25 | 11.25 | 11.25 | 11.25 | 11.25 | 11.25 | 0 |
| acetate | | | | | | | |
| Butyl acetate | 0 | 0 | 0 | 0 | 0 | 0 | 36.32 |
| Methyl ethyl ketone | 0 | 0 | 0 | 0 | 0 | 0 | 9.792 |
| NCO % | 0.0% | 0.0% | 0.0% | 0.0% | 0.0% | 0.0% | 0.0% |
| Molar Ratio | 100:0 | 82:18 | 60:40 | 20:80 | 40:60 | 20:80 | 100:0 |
| aminosilane: DMP | | | | | | | |
| Solids content [%] | 74.9 | 70.9% | 72.3% | 75% | 75% | 75% | 53.4% |

### Preparation of Base Formulations A and B

The ingredients of two different base formulations A and B were mixed in the amounts shown in Table 2. All amounts are in gram.

TABLE 2
Composition of base formulations A and B

| | Base | Base |
|---|---|---|
| Ingredients | formulation A | formulation B |
| Hydroxy-functional polyacrylate I ¹⁾ | 20.00 | 29.11 |
| Hydroxy-functional polyester ²⁾ | 8.20 | 0.00 |
| Aminoplast crosslinker I ³⁾ | 8.46 | 7.23 |
| Aminoplast crosslinker II ⁴⁾ | 10.00 | 8.39 |
| BUTANOL | 3.80 | 1.79 |
| Sag Control Agent ⁵⁾ | 21.40 | 23.13 |
| Blocked polyisocyanate crosslinker ⁶⁾ | 4.70 | 4.02 |
| Hydroxy-functional Polyacrylate II ⁷⁾ | 1.00 | 0.00 |
| XYLOL | 12.00 | 5.54 |
| SOLVENTNAPHTHA 180/210 | 4.70 | 3.93 |
| Butylglycol acetate | 2.90 | 2.50 |
| Butyldiglycol acetate | 0.00 | 0.46 |
| Methoxypropanol | 0.00 | 0.46 |
| HALS ⁸⁾ | 0.33 | 0.28 |
| UV absorber ⁹⁾ | 0.44 | 0.36 |
| Light stabilizer ¹⁰⁾ | 0.76 | 0.68 |
| Leveling Additive I ¹¹⁾ | 0.20 | 0.00 |
| Leveling Additive II ¹²⁾ | 0.00 | 0.18 |
| Dispersing Agent ¹³⁾ | 0.05 | 0.04 |
| De-aerating Agent ¹⁴⁾ | 0.10 | 0.27 |
| Catalyst I ¹⁵⁾ | 0.00 | 0.38 |
| Catalyst II ¹⁶⁾ | 0.96 | 0.55 |

¹⁾ OH-functional poly(meth)acrylate (Tg < 0° C.; OH value approx. 150 mg KOH/g, 65 wt.-% solids)
²⁾ OH-functional low molecular weight polyester (Tg approx. 10° C.; OH value approx. 160 mg KOH/g; 60 wt.-% solids)
³⁾ CYMEL 202, 81% B, commercially available from Allnex
⁴⁾ SETAMINE US-138 BB-70, 70% B, commercially available from Allnex
⁵⁾ Urea crystals precipitated in polyacrylate resin (60 wt.-% solids)
⁶⁾ DESMODUR PL 350 MPA/SN, commercially available from Covestro (HDI trimer blocked with DMP; solids content 75 wt.-%)
⁷⁾ OH-functional polyacrylate (Tg < 0° C.; OH value approx. 130 mg KOH/g)
⁸⁾ Tinuvin ® 292, sterically hindered amine light stabilizer (BASF SE)
⁹⁾ Tinuvin ® 384-2, light stabilizer based on benzotriazole (BASF SE)
¹⁰⁾ Tinuvin ® 5248; mixture of HALS and UV absorber (BASF SE)
¹¹⁾ BYK-325 N 52% (BYK Chemie GmbH)
¹²⁾ BYK-315 N (BYK Chemie GmbH)
¹³⁾ commercially available from BYK Chemie GmbH
¹⁴⁾ commercially available from King Industries, Inc.
¹⁵⁾ amine-blocked dodecylbenzenesulfonic acid (DDBSA) solution (70 wt.-% solids)
¹⁶⁾ amine-blocked p-toluene sulfonic acid solution CYCAT 4045, 42% MED (from Allnex)

### Preparation and Stability of Clear Coating Materials

The ingredients of comparative coating materials CCC1 and CCC2 as well as the ingredients of the inventive coating materials ICC1 to ICC21 were mixed in the amounts shown in Tables 3 and 4 by adding to either base formulation A or B (Table 2) 0, 5, 10, or 20 wt.-% of one crosslinking agents E1 to E7. All amounts are in gram. In addition, the stability of the coating materials observed by monitoring the increase of viscosity over time and at an elevated temperature of 40° C. is shown.

TABLE 3
Formulation and viscosity of different clearcoat materials

| | | Inventive Clear Coat Materials ICC1 to ICC12 | | | | | | | | | | | | |
|---|---|---|---|---|---|---|---|---|---|---|---|---|---|---|
| | | and Comparative Clear Coat Material CCC1 | | | | | | | | | | | | |
| | | CCC1 | ICC1 | ICC2 | ICC3 | ICC4 | ICC5 | ICC6 | ICC7 | ICC8 | ICC9 | ICC10 | ICC11 | ICC12 |
| Base Clearcoat A | | 100.0 | 96.70 | 93.70 | 88.20 | 96.6 | 93.40 | 87.60 | 96.65 | 93.50 | 87.80 | 95.55 | 91.40 | 84.20 |
| E1 | | | 3.30 | 6.30 | 11.80 | | | | | | | | | |
| E2 | | | | | | 3.40 | 6.60 | 12.40 | | | | | | |
| E3 | | | | | | | | | 3.35 | 6.50 | 12.20 | | | |
| E7 | | | | | | | | | | | | 4.45 | 8.60 | 15.80 |
| Viscosity | Initial [s] | 29 | 29 | 29 | 29 | 29 | 29 | 30 | 30 | 30 | 30 | 30 | 29 | 28 |
| | 7 days/21 °C [s] | 32 | 32 | 32 | 32 | 32 | 32 | 33 | 33 | 33 | 34 | 32 | 32 | 32 |
| | 7 days/40 °C [s] | 42 | 43 | 43 | 45 | 43 | 44 | 44 | 45 | 45 | 46 | 40 | 39 | 36 |

TABLE 4
Formulation and viscosity of different clearcoat materials

| | | Inventive Clear Coat Materials ICC13 to ICC21 | | | | | | | | | |
|---|---|---|---|---|---|---|---|---|---|---|---|
| | | and Comparative Clear Coat Material CCC2 | | | | | | | | | |
| | | CCC2 | ICC13 | ICC14 | ICC15 | ICC16 | ICC17 | ICC18 | ICC19 | ICC20 | ICC21 |
| Base Clearcoat B | | 100 | 85.05 | 81.10 | 74.45 | 85.05 | 81.10 | 74.45 | 85.05 | 81.10 | 74.45 |
| E4 | | | 3.05 | 6.00 | 10.60 | | | | | | |
| E5 | | | | | | 3.05 | 6.00 | 10.60 | | | |
| E6 | | | | | | | | | 3.05 | 6.00 | 10.60 |
| Solvent Naphtha 165/185 | | 10.70 | 11.90 | 13.05 | 14.95 | 11.90 | 13.05 | 14.95 | 11.90 | 13.05 | 14.95 |
| Viscosity | Initial [s] | 29 | 28 | 25 | 28 | 26 | 24 | 23 | 28 | 26 | 24 |
| | 7 days/21 °C [s] | 31 | 30 | 29 | 30 | 27 | 25 | 26 | 30 | 27 | 25 |
| | 7 days/40 °C [s] | 32 | 30 | 29 | 32 | 29 | 27 | 26 | 31 | 29 | 27 |

The stability of coating materials CCC1 to CCC2 and ICC1 to ICC21 was evaluated by monitoring the viscosity increase over time at ambient conditions (about 21° C.) and in an accelerated aging process at an elevated temperature of 40° C. The results in Tables 3 and 4 show only a minor increase of the viscosity over time observed for base formulations A and B (CCC1 and CCC2).

Coating materials according to the invention comprising crosslinking agents according to the present invention (ICC1 to ICC12, and ICC13 to ICC21) show a very similar and therefore acceptable low increase in viscosity.

### Preparation of Multilayer Coatings (MC)

Steel panels were first pretreated with Gardobond R zinc phosphatation (commercially available from Chemetall GmbH) and afterwards coated with ED-coat (Cathogard 800, commercially available from BASF Coatings GmbH) in a dry film thickness of 17 to 25 μm.

### Preparation of Multilayer Coatings

The electrodeposited panels were coated as described below using a pneumatic spray gun at a temperature of 25° C. and a relative humidity of 65%. A primer (UniBloc, BASF Coatings GmbH) was applied to the electrodeposited panels such that the film thickness after curing at 150° C. for 15 min was 40±5 μm. A commercially available aqueous basecoat (Colorbrite, BASF Coatings GmbH) was applied such that the film thickness in the cured state was 13.5±1.5 μm. Flash-off was 4 min at room temperature and 10 min at 80° C. (oven time and oven temperature). In the last step the respective coating material CCC1 and ICC1 to ICC12 described in Table 3 above was applied wet-in-wet on top of the basecoat layer. After a flash-off for approximately 7 minutes coating materials CCC1 and ICC1 to ICC12 were cured together with the basecoat for 15 min at 140° C. The dry film thickness of the clearcoat layer in the cured state was 35 to 40 μm.

### Preparation of Multilayer Coatings II

The electrodeposited panels were coated as described below using a pneumatic spray gun at a temperature of 25° C. and a relative humidity of 65%. A primer (Gris Moyen, BASF Coatings GmbH) was applied to the electrodeposited panels such that the film thickness after curing was approx. 14 μm, 12 min flash-off at room temperature. A commercially available aqueous basecoat (Noir Perla Nera, BASF Coatings GmbH) was applied such that the film thickness in the cured state was 13.5±1.5 μm. Flash-off was 24 min at room temperature. In the last step the respective coating material CCC2 and ICC13 to ICC2 described in Table 4 above were applied wet-in-wet on top of the basecoat layer. After a flash-off for approximately 12 minutes all layers were cured together for 20 min at 140° C. The dry film thickness of the clearcoat layer in the cured state was 35 to 40 μm.

Properties of the Substrates Coated with the Multilayer Coatings (MC)

The results obtained for the multilayer coatings (MC) prepared as described above using the coating material of the present invention to form a clearcoat are listed in Tables 5 and 6.

TABLE 5
Results of multilayer coatings with different clear coats

| | | Inventive Clear Coat Materials ICC1 to ICC12 | | | | | | | | | | | | |
|---|---|---|---|---|---|---|---|---|---|---|---|---|---|---|
| | | and Comparative Clear Coat Material CCC1 | | | | | | | | | | | | |
| | | CCC1 | ICC1 | ICC2 | ICC3 | ICC4 | ICC5 | ICC6 | ICC7 | ICC8 | ICC9 | ICC10 | CC11 | ICC12 |
| Base | | 100.0 | 96.70 | 93.70 | 88.20 | 96.6 | 93.40 | 87.60 | 96.65 | 93.50 | 87.80 | 95.55 | 91.40 | 84.20 |
| Clearcoat A | | | | | | | | | | | | | | |
| E1 | | | 3.30 | 6.30 | 11.80 | | | | | | | | | |
| E2 | | | | | | 3.40 | 6.60 | 12.40 | | | | | | |
| E3 | | | | | | | | | 3.35 | 6.50 | 12.20 | | | |
| E7 | | | | | | | | | | | | 4.45 | 8.60 | 15.80 |
| Gloss | Initial Gloss 60° [%] | 95 | 95 | 95 | 94 | 94 | 95 | 94 | 95 | 94 | 94 | 95 | 95 | 94 |
| | Residual Gloss 60° [%] | 61 | 63 | 66 | 67 | 66 | 76 | 83 | 80 | 73 | 83 | 76 | 85 | 83 |
| | Δ Gloss 60° | 34 | 32 | 29 | 27 | 28 | 19 | 11 | 15 | 21 | 11 | 19 | 10 | 11 |
| | Crockmeter/PMMA | 38 | 36 | 32 | 31 | 31 | 22 | 14 | 18 | 28 | 15 | 22 | 13 | 14 |

TABLE 6
Results of multilayer coatings with different clear coats

| | | Inventive Clear Coat Materials ICC13 to ICC21 | | | | | | | | | |
|---|---|---|---|---|---|---|---|---|---|---|---|
| | | and Comparative Clear Coat Material CCC2 | | | | | | | | | |
| | | CCC2 | ICC13 | ICC14 | ICC15 | ICC16 | ICC17 | ICC18 | ICC19 | ICC20 | ICC21 |
| Base Clearcoat B | | 100.00 | 85.05 | 81.10 | 74.45 | 85.05 | 81.10 | 74.45 | 85.05 | 81.10 | 74.45 |
| E4 | | | 3.05 | 6.00 | 10.60 | | | | | | |
| E5 | | | | | | 3.05 | 6.00 | 10.60 | | | |
| E6 | | | | | | | | | 3.05 | 6.00 | 10.60 |
| Gloss | Initial Gloss 60° [%] | 95 | 95 | 95 | 96 | 95 | 96 | 95 | 95 | 96 | 96 |
| | Residual Gloss 60° [%] | 62 | 71 | 85 | 84 | 80 | 76 | 83 | 64 | 81 | 70 |
| | Δ Gloss 60° | 34 | 25 | 11 | 12 | 16 | 20 | 18 | 30 | 14 | 25 |
| | Crockmeter/PMMA | 43 | 34 | 20 | 21 | 25 | 29 | 28 | 40 | 24 | 35 |

As indicated in Tables 5 and 6, all multilayer coatings obtained from the Inventive Examples retain a better residual gloss after carrying out the crockmeter test, when compared with the respective comparative examples CCC1 and CCC2 not comprising any of the crosslinking agents (B).

Furthermore, as indicated in Table 5, the series of multilayer coatings CCC1 and ICC1 to ICC12 obtained from the clearcoats comprising base-formula A show, that the retention of the residual gloss after carrying out the crockmeter test is higher with an increasing amount of crosslinking agents (B). Comparison of the residual gloss of ICC4 to ICC9 with ICC1 to ICC3 further indicates, that addition of DMP as blocking agent has a further beneficial effect on the residual gloss in HDI-trimer based compositions, while an even better performance has been obtained for ICC10 to ICC12 comprising crosslinking agent E7.

In Table 6, if comparing ICC16 to ICC18 with ICC19 to ICC20 it is shown that an increasing molar amount of the blocking agent, i.e., a decreasing amount of aminosilane groups is less preferred with respect to the scratch resistance. This is effect is herein attributed to the presence of cycloaliphatic moieties of the IPDI structure, which is partially present in the crosslinkers used in the afore-mentioned examples. In case of linear aliphatic moieties, as present in HDI and thus in the crosslinker used in examples ICC13 to ICC15 the presence of a high molar amount of blocked isocyanate groups versa aminosilane groups seems to have less effect.

1. A one-pack liquid coating material, comprising
a) at least one hydroxy-functional polymer (A) selected from the group consisting of (meth)acrylic polymers, polyesters and polyurethanes;
b) at least one crosslinking agent (B) of general formula (I) 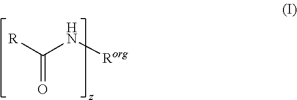
wherein
R^{org} is an organic residue, and z is in a range of from 2.0 to 9.0, and
R is selected from the group consisting of alkoxysilane groups containing groups of formulae (II) and (III) and isocyanate blocking groups,
formula (II) being 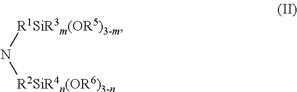
wherein
R¹ and R² are independently from each other selected from the group consisting of linear, branched, and cyclic alkylene groups having 1 to 10 carbon atoms,
R³ and R⁴ are independently from each other selected from the group consisting of linear, branched, and cyclic alkyl groups having 1 to 10 carbon atoms,
R⁵ and R⁶ are independently selected from the group consisting of alkyl residues containing 2, 3 or 4 carbon atoms, and
n and m are independently of each other selected from the group consisting of 0, 1 or 2;
formula (III) being 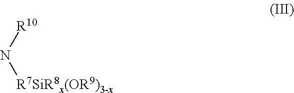
wherein
R⁷ is selected from the group consisting of linear, branched, and cyclic alkylene groups having 1 to 10 carbon atoms,
R⁸ is selected from the group consisting of linear, branched, and cyclic alkyl groups having 1 to 10 carbon atoms,
R⁹ is selected from the group consisting of alkyl residues containing 2, 3 or 4 carbon atoms,
R¹⁰ is selected from the group consisting of H and linear, branched, and cyclic alkyl groups having 1 to 10 carbon atoms and
x is 0, 1 or 2; and
isocyanate blocking groups R^{b} being formally derived from isocyanate blocking agents of formula H—R^{b} by formal removal of H at the atom of residue R^{b}, which is bound to the carbon of the C═O group in formula (I);
with the proviso that on average at least 15 mole-% of the entirety of residues R in formula (I) are residues of formula (II), and
c) an aprotic organic solvent (C), wherein
2.0 to 30 wt.-% of the at least one crosslinking agent (B) are contained in the one-pack coating material, based on the total weight of the one-pack coating material.

2. The one-pack coating material according to claim 1, wherein
in formula (I)
z is in a range of from 2.0 to 6.0;
in formula (II)
R¹ and R² are linear alkylene groups independently having 3 to 6 carbon atoms,
R³ and R⁴ are linear alkyl groups independently having 1 to 4 carbon atoms,
R⁵ and R⁶ are linear alkyl residues independently having 2 or 3 carbon atoms, and
m and n each independently is 0 or 1;
in formula (III)
R⁷ is a linear alkylene group having 3 to 6 carbon atoms,
R⁸ is a linear alkyl group having 1 to 4 carbon atoms,
R⁹ is a linear alkyl residue having 2 or 3 carbon atoms,
R¹⁰ is H or a linear alkyl group having 2 to 8 carbon atoms; and
x is 0 or 1; and
the blocking agent H—R^{b} is selected from the group consisting of oximes and pyrazoles.

3. The one-pack coating material according to claim 1, wherein
for each combination of
residues R¹ with R⁵,
residues R² with R⁶, and
residues R⁷ with R⁹, respectively,
the sum of carbon atoms of both residues R¹ and R⁵, R² and R⁶, and R⁷ and R⁹ respectively, is at least 4.

4. The one-pack coating material according to claim 1, wherein
in case R^{org} is a residue which contains one or more cycloaliphatic moieties of cycloaliphatic moiety containing diisocyanates, the molar percentage ranges of the entirety of residues R in the crosslinking agent (B) are as follows:
20 to 100 mole-% are residues of formula (II),
0 to 10 mole-% are residues of formula (III), and
0 to 80 mole-% are isocyanate blocking groups; and
in case R^{org} is a residue which contains no cycloaliphatic moieties of cycloaliphatic moiety containing diisocyanates, but linear aliphatic moieties of linear aliphatic moiety containing diisocyanates, the molar percentage ranges of the entirety of residues R in the crosslinking agent (B) are as follows:
20 to 90 mole-% are residues of formula (II),
0 to 10 mole-% are residues of formula (III), and
10 to 80 mole-%, are isocyanate blocking groups.

5. The one-pack coating material according to claim 1, wherein the one-pack coating material further comprises one or more of
d) one or more blocked further crosslinking agents (D) selected from the group consisting of blocked di- or polyisocyanates, which do not contain hydrolysable silane groups (D1) and aminoplast resins (D2);
e) one or more catalysts (E) for catalyzing the crosslinking reaction in the one-pack coating material;
f) one or more colorants (F);
g) one or more coatings additives (G); and
h) one or more protic solvents (H).

6. The one-pack coating material according to claim 5, wherein the one or more catalysts (E) are selected from the group consisting of acidic catalysts and organometallic catalysts.

7. The one-pack coating material according to claim 6, wherein the acidic catalysts are selected from the group of sulfonic acids and amine-blocked sulfonic acids.

8. The one-pack coating material according to claim 5, wherein it contains
10 to 50 wt.-% of the one or more hydroxy-functional polymers (A);
2.0 to 30 wt.-% of the one or more crosslinking agents (B);
15 to 65 wt. % of the one or more aprotic organic solvent (C);
0 to 10 wt.-% of the one or more blocked diisocyanates and/or the one or more blocked polyisocyanates (D1), which do not contain hydrolysable silane groups;
0 to 30 wt.-% of the one or more aminoplast resins (D2);
0 to 2 wt.-% of the one or more catalysts (E);
0 to 5 wt.-% of the one or more colorants (F);
0 to 15 wt.-% of the one or more coatings additives (G); and
0 to 20 wt.-% of the one or more protic solvents (H);
all weight-percentages (wt.-%) being based on the total weight of the one-pack coating material.

9. The one-pack coating material according to claim 1, the wherein it contains one or more aminoplast resins (D2).

10. The one-pack coating material according to claim 9, wherein the one-pack coating material, based on the total weight of the one-pack coating material, contains 2.0 to 25 wt.-% of the one or more crosslinking agents (B) and 5 to 25 wt.-% of the one or more aminoplast resins (D2).

11. The one-pack coating material according to claim 1, the wherein it contains one or more protic solvents (H) in an amount of up to 20 wt.-% based on the total weight of the one-pack coating material.

12. The one-pack coating material according to claim 1, the wherein it contains not more than 1.0 wt.-% water based on the total weight of the coating material and/or not more than 2.0 wt.-% of free isocyanate groups, based on the total weight of the coating material.

13. The one-pack coating material according to claim 1, wherein the one-pack coating material is a one-pack clear coat material.

14. The one-pack coating material according to claim 1, wherein the one-pack coating material is an automotive coating material.

15. A method for forming a coating on a substrate(S) comprising the following steps:
(1) applying a coating material of claim 1 onto the substrate(S);
(2) forming a coating film from the coating material applied in step (1); and
(3) curing the coating film formed in step (2).

16. A coated substrate obtained by the method of claim 15.

17. A multilayer coating comprising at least two coating layers, wherein at least one of the coating layers is formed from the coating material claim 1.

18. A substrate coated with the multilayer coating of claim 17.

19. The multilayer coating of claim 17, wherein the at least two coating layers comprise at least one basecoat layer and at least one clearcoat layer.

20. The multilayer coating of claim 19, wherein the at least one clearcoat layer is formed from the coating material.
